(19) United States
(12) Patent Application Publication
(10) Pub. No.: US 2003/0125967 A1
(43) Pub. Date: Jul. 3, 2003

(54) Coding device output

(76) Inventors: Mark Josephsen, Boise, ID (US); Curtis Reese, Boise, ID (US); Shelly Davey, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/033,643

(22) Filed: Dec. 27, 2001

(51) Int. Cl. G06F 17/60

(52) U.S. Cl. 705/1

(57) ABSTRACT

Devices and methods for coding and/or outputting text and/or image information.

### TECHNICAL FIELD

The subject matter disclosed herein relates to coding of output from a device.

### BACKGROUND

A need exists for methods and devices for coding output, in particular, coding output with information related to authorship, ownership and/or a transaction (e.g., a licensing transaction) and/or outputting information based on information related to authorship, ownership and/or a transaction.

### SUMMARY

Devices and methods for coding device output with authorship, ownership and/or transaction information and/or outputting information based on information related to authorship, ownership and/or a transaction.

### BRIEF DESCRIPTION OF THE DRAWINGS

Various exemplary methods and/or devices are illustrated by way of example and not limitation in the figures of the accompanying drawings. The same numbers are used throughout the figures to reference like components and/or features.

FIG. 1 is an illustration of a network environment in which multiple servers, workstations, and other devices are coupled to one another via a data communication network.

FIG. 2 is a block diagram showing pertinent components of an exemplary device suitable for use with various exemplary systems and/or methods described herein.

FIG. 3 is a block diagram showing pertinent components of a computer workstation suitable for use with various exemplary systems and/or methods described herein.

FIG. 4 is a block diagram of an exemplary coding device showing various functional blocks.

FIG. 5 is a block diagram of an exemplary coding method.

FIG. 6 is an illustration of an exemplary hard copy output having code information and text and/or image information.

FIG. 7 is a block diagram of an exemplary coding method including connecting to a Web site.

FIG. 8 is an illustration of an exemplary network environment including a coding device and servers.

FIG. 9 is a block diagram of an exemplary license agreement method.

FIG. 10 is a block diagram of another exemplary license agreement method.

FIG. 11 is a block diagram of an exemplary code recognition method.

### DETAILED DESCRIPTION

Described below are exemplary devices and methods for coding information and/or outputting information based on code information. For example, a coding device optionally comprises an input for inputting text and/or image information; a network interface for receiving code information pertaining to authorship and/or ownership of the text and/or image information; and a printer for printing the text and/or image information onto a medium based on the code information. As described herein, the term “code information” refers to any information usually extraneous to text and/or image information and generally relating to authorship, ownership and/or other rights in text and/or image information. The term “image” includes, but is not limited to, graphical images and photographic images.

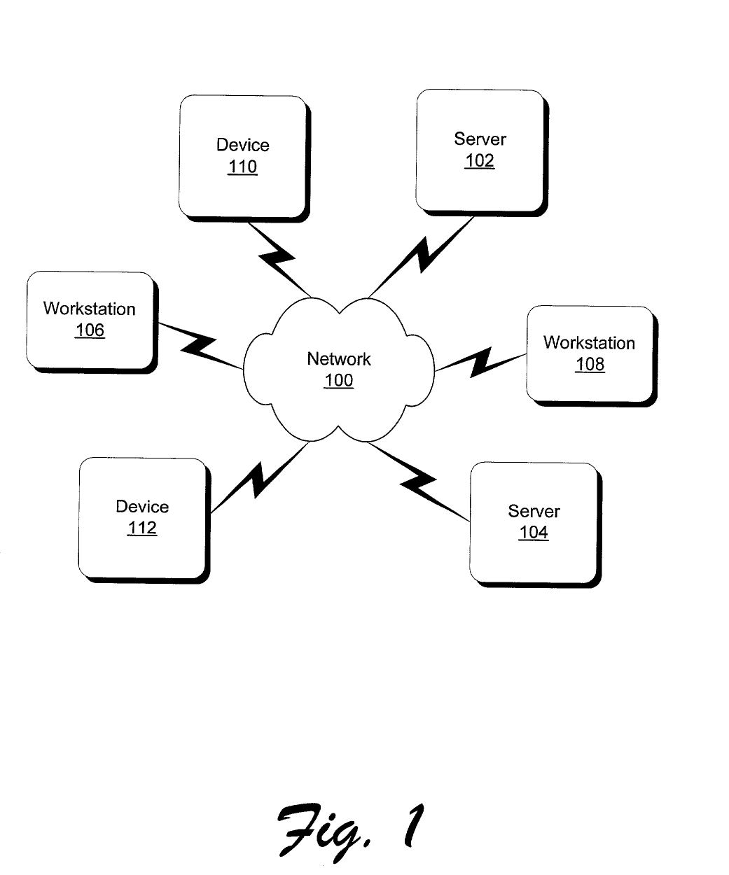

FIG. 1 illustrates a network environment that includes multiple servers, workstations, and devices coupled to one another via a data communication network 100. The network 100 couples together servers 102, 104, computer workstations 106, 108, and devices 110, 112. The network 100 can be any type of network, such as a local area network (LAN) or a wide area network (WAN), using any type of network topology and any network communication protocol. The network may include wired, wireless or a combination of wired and wireless links. In a particular embodiment, the network 100 is the Internet. Although only a few servers, workstations and devices are shown coupled to the network 100, a typical network may include tens or hundreds of servers, workstations, and/or devices coupled to one another. Furthermore, the network 100 may be coupled to one or more other networks, thereby providing coupling between a greater number of servers, workstations and/or devices.

The servers 102, 104 may be file servers, email servers, database servers, print servers, or any other type of network server. The workstations 106, 108 can be any type of computing device, such as, but not limited to, a personal computer. Particular exemplary methods and/or systems include coding devices that also function as printers, for example, laser, ink, bubble or, in general, any type of printer. Furthermore, teachings presented herein optionally apply to any type of printing device, such as scanners, copiers and fax machines. Details of coding devices (e.g., coding devices printers) appear below; some details of such devices and/or printers are known in the art.

Although not shown in FIG. 1, one or more workstations and/or servers may contain a print rendering engine capable of converting raw print job information into a particular format (e.g., language) understood by certain types of printers. A printer menu editor application is optionally executed on a workstation 106, 108, or on a server 102, 104, to create or modify a printer menu structure.

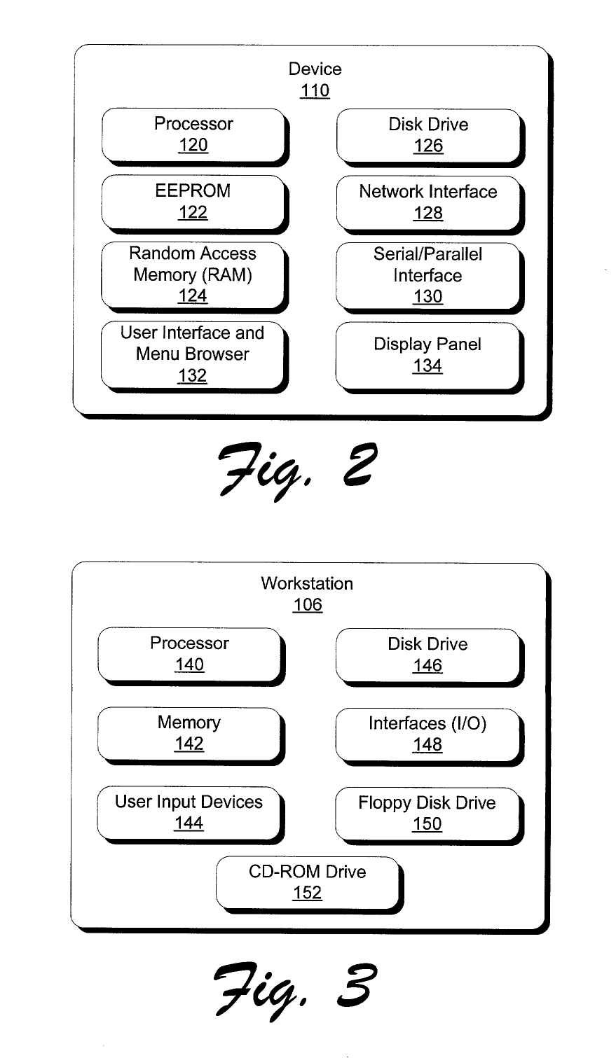

FIG. 2 is a block diagram showing pertinent components of a device 110 suitable (e.g., device 110 of FIG. 1) for use as a coding device and suitable for use with various examples presented herein. As shown in FIG. 2, the device 110 includes a processor 120, an electrically erasable programmable read-only memory (EEPROM) 122, and a random access memory (RAM) 124. The processor 120 processes various instructions necessary to operate the device 110 and/or communicate with other devices. The EEPROM 122 and the RAM 124 store various information such as, but not limited to, configuration information, fonts, templates, data being printed, and menu structure information. Although not shown in FIG. 2, a particular device may also contain a ROM (non-erasable) in place of or in addition to the EEPROM 122.

The exemplary device 110, as shown in FIG. 2, also includes a disk drive 126, a network interface 128, and a serial/parallel interface 130. The disk drive 126 provides additional storage for data being output or other information used by the device 110. Although both the RAM 124 and the disk drive 126 are illustrated in FIG. 2, a particular device may contain either a RAM 124 or a disk drive 126, depending on the storage needs of the device. For example, where the device is an inexpensive printer, such a printer may contain a small amount of RAM 124 and no disk drive 126, thereby reducing the manufacturing cost of the printer. The network interface 128 provides a connection between the device 110 and a data communication network, such as the network 100. The network interface 128 allows devices coupled to a common data communication network to send jobs, menu data, and other information to the device 110 via a network (e.g., network 100 of FIG. 1). Similarly, the serial/parallel interface 130 provides a data communication path directly between the device 110 and another device, such as a workstation, server, or other computing device. Although the device 110 shown in FIG. 2 has two interfaces (the network interface 128 and the serial/parallel interface 130), an exemplary device may include one interface or more than two interfaces.

As shown in FIG. 2, the device 110 also contains a user interface/menu browser 132 and a display panel 134. The user interface 132 may include a series of buttons, switches or other indicators that are optionally usable by a user of the device 110. The display panel 134 includes a graphical display that typically provides information regarding the status of the device and the current options available through the menu structure. The device 110 display panel 134 may display various menu options to a user of the device 110. The display panel 134 and associated control buttons optionally allow a user of the device to navigate the device's menu structure.

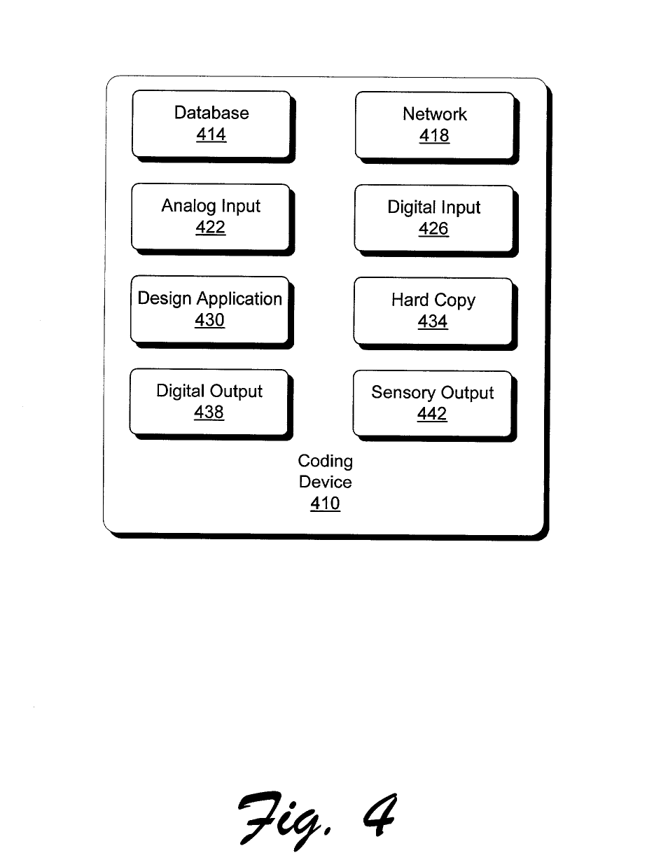

FIG. 3 is a block diagram showing pertinent components of a computer workstation 106 in accordance with exemplary methods and/or systems described herein. The workstation 106 includes a processor 140, a memory 142 (such as ROM and RAM), user input devices 144, a disk drive 146, interfaces 148 for inputting and outputting data, a floppy disk drive 150, and a CD-ROM drive 152. The processor 140 performs various instructions to control the operation of the workstation 106. The memory 142, the disk drive 46, the floppy disk drive 150, and the CD-ROM drive 152 provide data storage mechanisms. The user input devices 144 include a keyboard, mouse, pointing device, or other mechanism for inputting information to the workstation 106. The interfaces 148 provide a mechanism for the workstation 106 to communicate with other devices. A server (e.g., servers 102, 104 of FIG. 1), typically includes at least some of the workstation 106 features.

Various coding devices described herein have print capabilities and printer specific software (or firmware) and software (or firmware) for all paper handling and/or print associated devices. Regarding coding devices having print capabilities, various functions relate to printing, paper handling, and/or data communication. Examples of the functions performed by a coding device having print capabilities include, but are not limited to: printing; multiple-original-printing (sometimes referred to, or including, mopy printing); copying; sending/receiving fax; sending/receiving e-mail; image acquisition; text recognition; source paper handling (such as high capacity input (HCI); trays having differing paper sizes/types; envelope trays); destination paper handling (such as stacking; stapling; sorting; collating; mailboxes); and data acquisition (network; serial; USB; parallel; IR; floppy disk; hard disk; RAM; flash cards; any other media).

An exemplary function, as listed above, is mopy printing. Mopy-enabled printers utilize intelligent software (or firmware) and host software to improve throughput and reduce or eliminate aforementioned issues. In mopy printing, a printer driver typically transmits a file only once and sends appropriate header information (e.g., the number of copies) to the printer for rasterization and spooling. In general, the printer rasterizes the job only once and then prints multiple, original copies in the manner determined by a user. Mopy printing is particularly useful for complex jobs that slow down the printer when the first copy is created or takes a long time to transmit over a network. Various coding functions described herein are particularly useful for mopy printing of documents including text and/or image information.

Commercially available printers having at least some of the aforementioned functions include the Hewlett Packard (HP) LASERJET® 9000 printers (Palo Alto, Calif.). Such printers optionally include e-enabled print management software (e.g., HP WEB JETADMIN®) that may perform the following management tasks: install printers, configure printer options, configure and install multiple printers at one time, troubleshoot printer problems, schedule discoveries to update the device cache during off-peak hours, search for a specific printer or group of printers based on a wide variety of criteria, check a printer's current status, check the status of a printer's consumables, verify the type of media loaded in a printer's trays, verify a printer's capabilities, organize printers by logical groups, and create a virtual office layout with dynamic site maps.

Additional device features may include: browser-compatible device management software having an embedded web server and administration software, e.g., HP WEB JETADMIN®, to deliver remote device management services and solutions for one-to-one and one-to-many device management; Internet software that may include easy custom Internet software disk replication utility to customize what options administrators will load to their systems (e.g., replicate a printer configuration across a network); administration software for easy intranet administration; Internet installer software for easy downloading and updating of software; software utility software to let a user or an administrator know when updates are available; Internet page set up utility software to format and print internet pages, and to poll the internet for addresses that a user (or device) has requested as well as schedule the printing of those selected pages at declared intervals.

A device may also have an ability to send automatic e-mail alerts, optionally configured to send preconfigured notifications of device problems and job status via e-mail to designated recipients on the network. An e-mail notice may even provide a hot link for ordering device supplies via the Internet.

A device may further include smart components. For example, a print supplies system may be activated upon installation of a smart print cartridge in a printer. Each smart print cartridge may feature its own chip which may help to measure and report toner levels, provide usage information, and assure job completion.

Network administrators within an organization typically use one or more device management applications to manage devices within an organizational or corporate intranet. A device is any device that can be connected to a computer or network such as a printer, copier, scanner, fax machine, data storage system, lab equipment, a home entertainment device, and the like. In particular, as described in detail herein, a device is a coding device. Commercially available device management applications include HP JETADMIN® and HP WEB JETADMIN® products, which are typically used by network administrators to discover, install, monitor and troubleshoot network-connected devices.

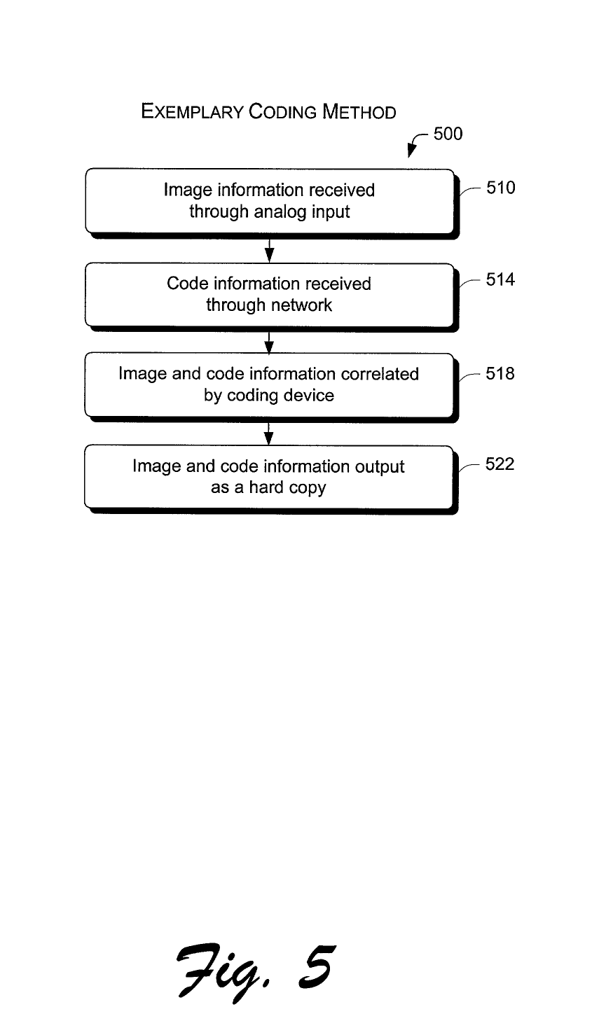

Referring to FIG. 4, a block diagram of an exemplary coding device 410 is shown (see, e.g., device 110, 112 FIG. 1 and FIG. 2). The coding device 410 includes functionality for receiving information, correlating code information to received information and outputting received information and/or code information. The coding device 410 receives information (code and/or other) from, for example, a database block 414, a network block 418, an analog input block 422, a digital input block 426, and/or a design application block 430. Further, the coding device 410 outputs information (code and/or other) from, for example, a hard copy block 434, a digital output block 438, and/or a sensory output block 442. The coding device 410 may also optionally generate code information rather than receiving code information from an internal and/or external source.

An exemplary coding device, such as the coding device 410 shown in FIG. 4, includes a network block (e.g., network block 418) capable of connecting to the Internet. Further, the network block typically includes software for various communication operations. Communication software includes, but is not limited to, Web server software capable of hosting Web pages. Such Web pages optionally provide information on device status, configuration, event logs, supplies, usage, network settings, administrative control, diagnostics, other devices, etc. For example, a device Web page hosted on a coding device Web server may allow a user to configure a coding device from a computer or other device. Commercially available software includes HP WEB JETADMIN® software, which is a Web browser-based management tool for proactive management and configuration of network-connected peripherals. When embedded in a coding device (e.g., a printer operating as a coding device), such software (or an equivalent thereof) may allow for remote installations, configurations, diagnostics, and management for a plurality of network peripherals from a common Web browser, which is optionally located on a coding device. Other software associated with Web browser and/or Web server software includes, but is not limited to, virtual machine software (e.g., HP CHAI® virtual machine, Sun Microsystems, Inc. JAVA® virtual machine, etc.). Additional communication software may perform e-mail operations and the like.

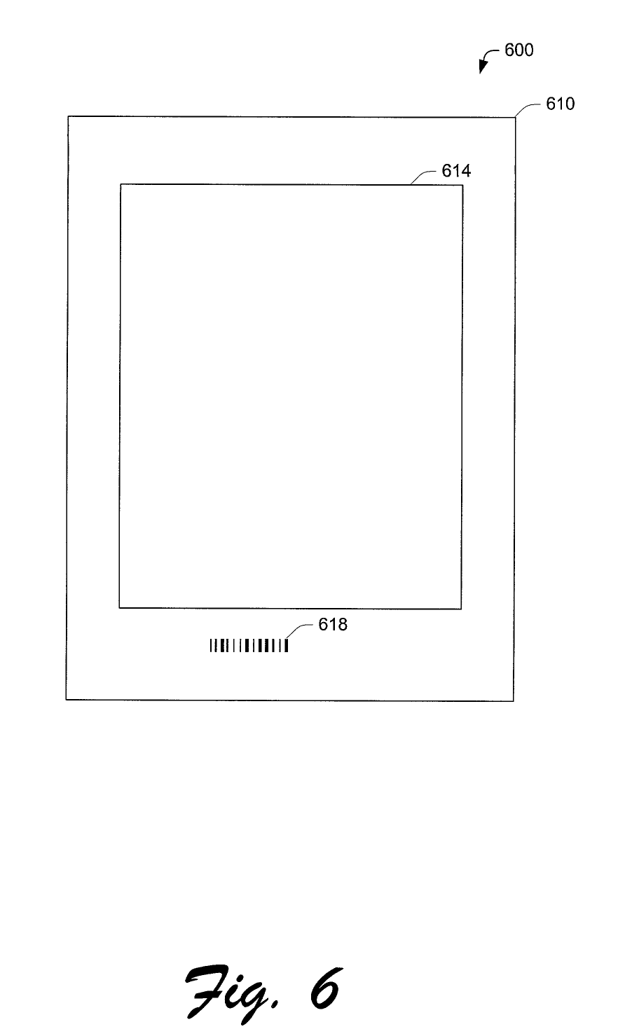

Referring to FIG. 5, a block diagram of an exemplary coding method 500 is shown. In a reception block 510, a coding device receives image information through an analog input. Suitable analog inputs for receiving image information include, but are not limited to, cameras and scanners, particularly cameras and scanners capable of converting image information from an analog to a digital format. For example, according to this exemplary coding method 500, a user may scan a photograph using a scanner to create a digital representation of the photograph. Further, in this example, the coding device may optionally include an integral scanner.

The exemplary coding method 500 also includes a reception block 514 for receiving code information through a network. Suitable networks include, but are not limited to, local area networks (LANs) and the Internet. For example, the user in the aforementioned example may input to the coding device the name of a photographer (or other entity) after scanning the photograph. The coding device may, in turn, connect to a Web site associated with the photographer via the Internet and, once connected, the coding device may receive code information from the Web site. According to this exemplary method 500, the code information may include a watermark, a trademark, trademark information, copyright information, and/or other information germane to the photographer, the photograph, and/or the digital representation of the photograph.

In a correlation block 518, the coding device correlates image and code information. For example, code information may include a URL, a copyright registration number associated with the photograph (and/or scanned image thereof) as issued by a governmental copyright office (e.g., U.S. Copyright Office). In this example, the correlation block 518 optionally converts the copyright registration number to a form printable as a bar code or an equivalent thereof. As shown in FIG. 5, an output block 522 follows wherein the coding device outputs the image and code information as a hard copy or, alternatively, the coding device outputs the image and code information to a device capable of producing a hard copy (e.g., a printer).

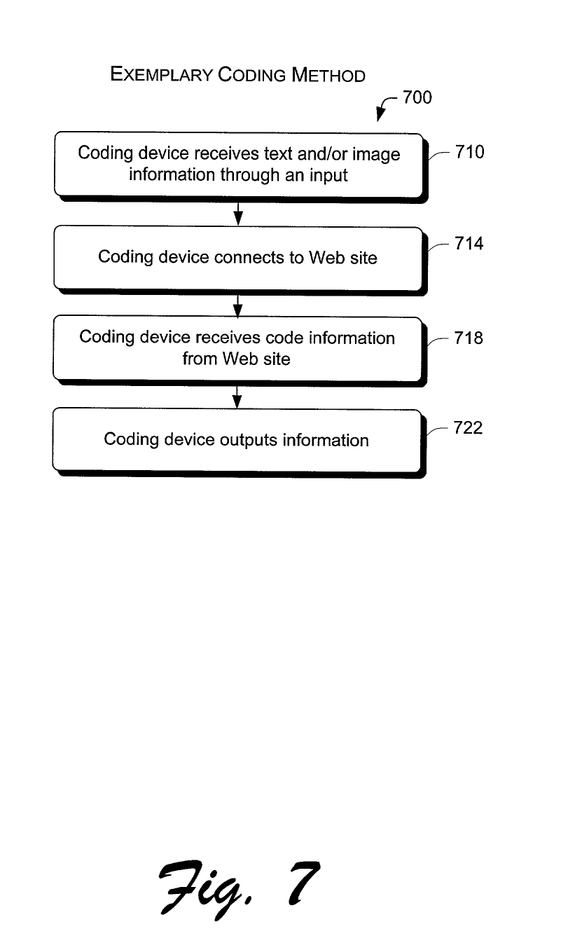

Referring to FIG. 6, an illustration of an exemplary hard copy 600 is shown, for example, a hard copy output-by-output block 522 of the exemplary coding method 500 of FIG. 5. In FIG. 6, the hard copy 600 comprises a page 610 displaying image information 614 and code information 618. For example, the code information 618 optionally appears in a bar code and/or other readable format. Image information 614 and code information 618 may appear anywhere on (or in) the page 610, including, but not limited to, a front side, a backside and/or an edge.

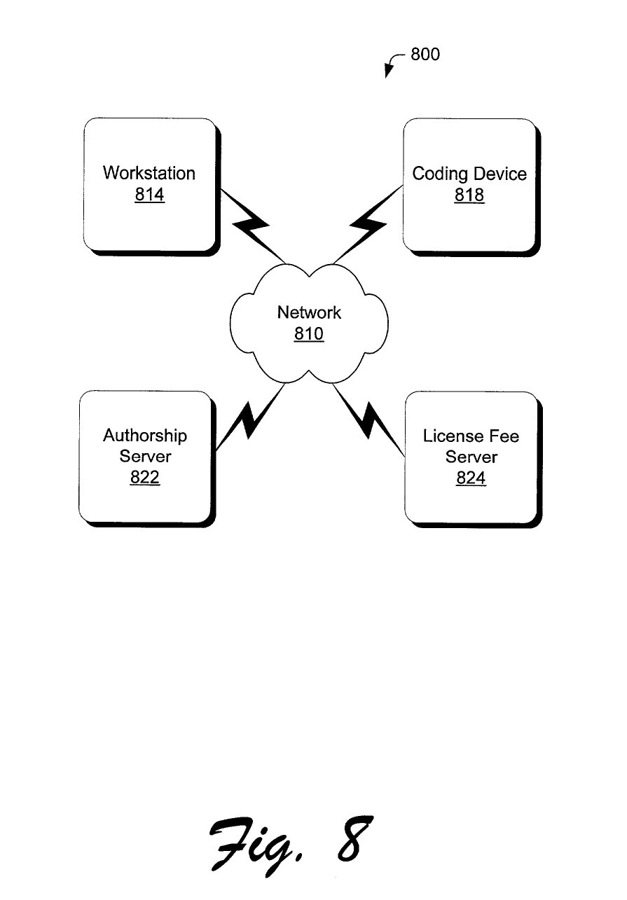

Referring to FIG. 7, a block diagram of an exemplary coding method 700 is shown. In a reception block 710, a coding device receives text and/or image information through an input, e.g., an analog input and/or a digital input. Suitable inputs for receiving text and/or image information include, but are not limited to, a computer (e.g., a server, a workstation, etc.), a digital media reader (e.g., CD drive, DVD drive, etc.) and a network interface. In a connection block 714, the coding device connects to a Web site based on information input by a user and/or information received in the reception block 710. For example, a user may input information about an author associated with the text and/or image information. In turn, the coding device may use the information about the author to locate a Web site and/or information at a Web site. In this example, information at a Web site may relate to authorization to use the text and/or image information (e.g., a license arrangement, etc.).

In yet another reception block 718, the coding device receives code information from the Web site. Following the aforementioned example, where the authorization involves a license arrangement or the like, the coding device may receive code information indicative of an agreement to abide by terms of a license. In addition, the coding device may require payment of a license fee prior to any further use of the text and/or image information (see, e.g., description below).

In an output block 722, the coding device outputs information. Such information optionally includes the received text and/or image information, the received code information, and/or other information germane to the received text and/or image information. For example, where the coding device receives text information in reception block 710 and receives license information in reception block 718, the coding device may output a license fee amount to a display and/or on a hard copy. In such an exemplary situation, the coding device waits for payment of the license fee prior to output of the received text information wherein payment options may include payment by credit card, debit card, money, token, and/or other means typically used in, for example, photocopying and/or Internet-based systems. In such an exemplary method 700, payment may also occur via an account managed at a Web site, including the Web site referred to in the description of the connection block 714.

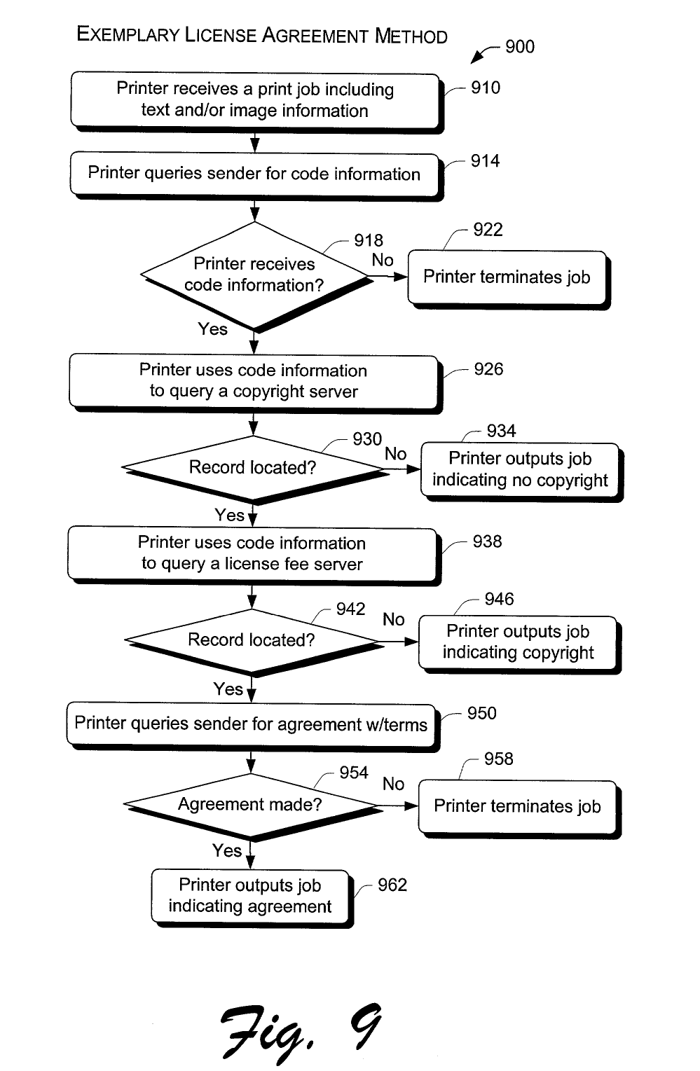

Referring to FIG. 8, a block diagram of an exemplary coding system 800 is shown. The coding system 800 includes a workstation 814, a coding device 818, an authorship server 822, and a license fee server 824. The coding system 800 includes features for execution of aforementioned methods 500, 700 as shown in FIGS. 5 and 7 wherein the coding device 818 functions as a printer. For example, a user at the workstation 814 may locate text and/or image information on the network 810 (or another network). Next, the user may send the text and/or image information to the coding device 818, for example, in the form of a print job. Upon receipt of the print job, the coding device 818 optionally detects code information inherent in the print job related to authorship/ownership in creative expression embodied in the text and/or image information. If the coding device 818 is unable to detect such code information, then the coding device 818 may direct a query to the workstation 814 for code information. For example, the coding device 818 may query the workstation 814 for an author's name. In the case that the workstation 814 transmits an author's name (or similar code information) to the coding device 818, then the coding device 818 may query a server (e.g., the authorship server 822 and/or the license fee server 824) for further information germane to the text and/or image information.

The coding device 818 of FIG. 8 optionally includes a Web browser wherein the coding device 818 may use the Web browser to connect to the authorship server 822, the license fee server 824 and/or another server. The authorship server 822, the license fee server 824, and/or other server optionally shares features with servers known in the music industry. For example, known music industry servers include a server maintained by The Harry Fox Agency, Inc. that provides information related to clearinghouse and monitoring services for licensing musical copyrights and a server maintained by BMI (an American performing rights organization) that operates to collects license fees on behalf of music creators that BMI represents.

The authorship server 822, license fee server 824 and/or other server may also share features with a server such as, but not limited to, the Library of Congress Information System (LOCIS) maintained by the U.S. Library of Congress. In addition, the coding device 818 may connect to a governmental (e.g., LOCIS) and/or non-governmental server (e.g., Harry Fox, BMI, etc.). According to the exemplary system 800, one server may provide all needed information or, alternatively, information may be provided by more than one server.

As described above with reference to the exemplary coding methods 500, 700 shown in FIGS. 5 and 7, a coding device outputs information. Accordingly, coding device 818 of the exemplary system 800 shown in FIG. 8, outputs information such as text and/or image information and/or code information received from the workstation 814 and/or a server (e.g., authorship server 822, license fee server 824). For example, the coding device 818 may output a hard copy such as hard copy 600 shown in FIG. 6. In this example, the code information 618 (shown as a bar code) may indicate that a license fee was paid for text and/or image information.

Referring to FIG. 9, a block diagram of an exemplary license agreement method 900 is shown. In a reception block 910, a printer operating as a coding device receives a print job from a sender that includes text and/or image information. In response to receipt of the print job, in a query block 914, the printer queries the sender for code information related to the text and/or image information. In a reception determination block 918, the printer determines whether the printer received requested code information. If in the determination block 918 the printer determines that no (or inadequate) code information was received, then in a termination block 922, the printer terminates the print job. If in the determination block 918, the printer determines that adequate code information was received, then in a second query block 926, the printer queries a copyright server using the code information.

In response to the copyright query, in a record location block 930, the printer determines whether the copyright server (or database) located a record corresponding to the code information. If the printer determines in the record location block 930 that the copyright server failed to locate a corresponding record, then the printer outputs the text and/or image information and/or the code information and an indication that no copyright registration (or application) was located for the text and/or image information. The indication that no copyright registration (or application) was located after a search may be considered code information as well since it is information typically germane to the text and/or image information.

If in the record location block 930, the printer determines that the server located a copyright record, then in a third query block 938, the printer queries a license fee server using code information (e.g., code information from a sender, code information from a copyright server, etc.). In a second record location block 942, the printer determines whether the license fee server (or database) located a record corresponding to the code information. If in the record location block 942 the printer determines that the license fee server failed to locate a corresponding record, then the printer outputs the text and/or image information, the code information, an indication that a copyright registration (or application) was located and/or an indication that no license arrangement was located for the for the text and/or image information. The indication that a copyright registration (or application) and/or that no license arrangement was located after a search (or searches) may be considered code information as well since such information is typically germane to the text and/or image information.

If the printer, in the record location block 942, determines that the license fee server located a license fee record, then in a fourth query block 950, the printer queries the print job sender for agreement with terms provided in the license fee record (e.g., payment of the license fee and/or for agreement with other terms provided in the license fee record). In an agreement determination block 954, the printer determines whether the sender agreed with the terms provided in the license fee record. If in the agreement determination block 954 the printer determines that the sender does not agree with the terms, then a termination block 958 follows wherein the printer terminates the print job. If the sender agrees with the terms, then the printer outputs the text and/or image information, code information, and/or an indication that the sender agreed to the terms of a license agreement. Information indicating that a sender has agreed to terms of a license may also be considered code information since it typically pertains to the text and/or image information as output by the printer.

In the exemplary license agreement method 900 described with reference to FIG. 9, information, indicating that the sender of a print job has agreed to a license, may take many forms. Examples of such forms include, but are not limited to, bar codes, text, graphics, etc. In another exemplary license agreement method, e.g., similar to the method 900 of FIG. 9, a scanner receives text and/or image information. In either method, the coding device may have printer and/or scanner functionalities.

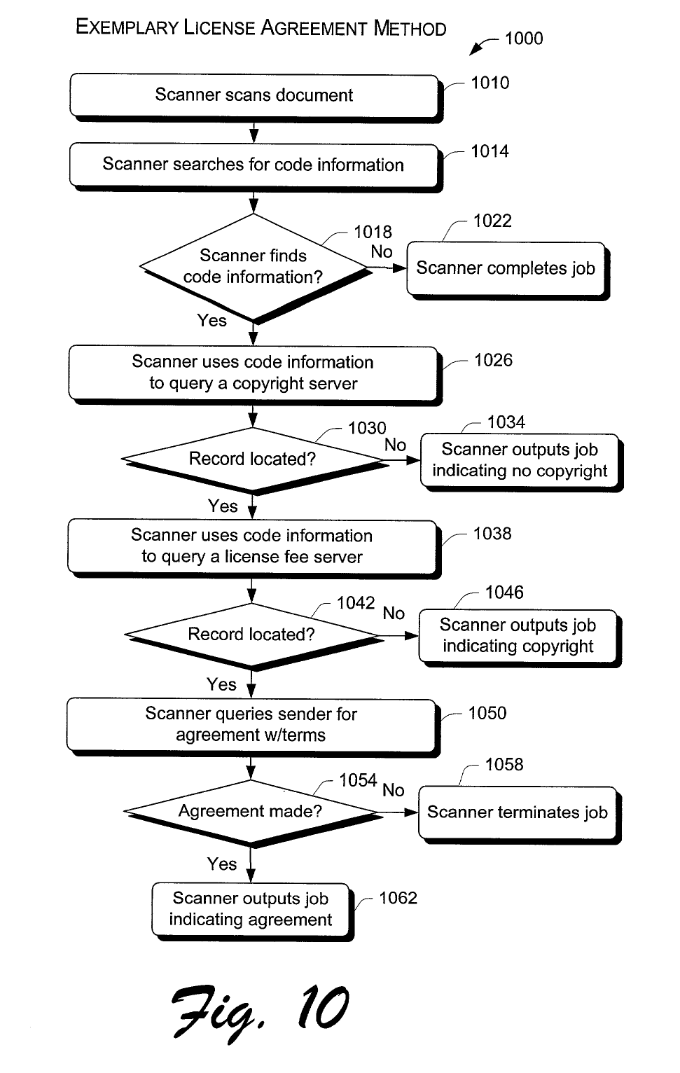

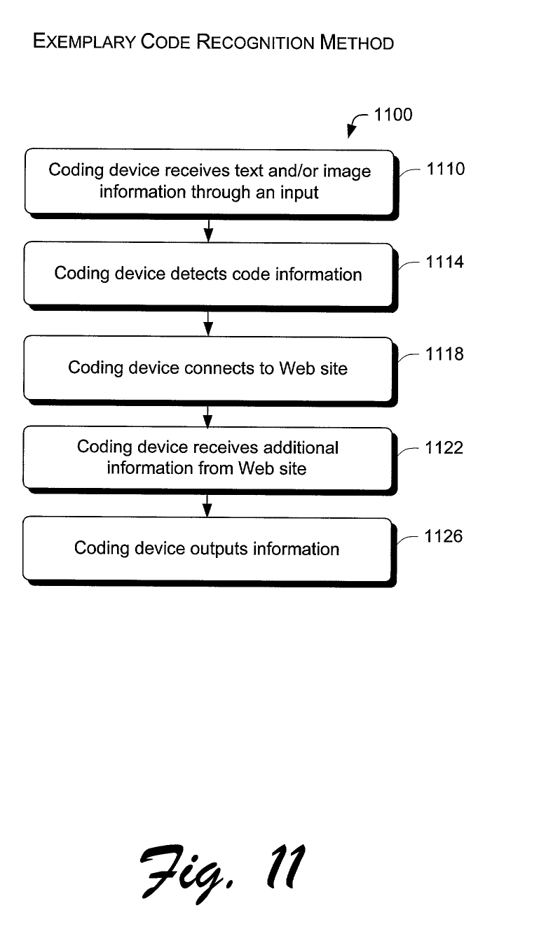

Referring to FIG. 10, a block diagram of another exemplary license agreement method 1000 is shown. In a reception block 1010, a scanner operating as a coding device scans a document, which may be referred to as a scan job. Through this process, the scanner receives information (e.g, text, image and/or code information). In a search block 1014, the scanner searches for code information during and/or after the scanning. Next, in a determination block 1018, the scanner determines whether code information was found. If in the determination block 1018 the scanner determines that no (or inadequate) code information was found, then the scanner optionally completes the job in a completion block 1022. In an alternative example, the scanner terminates the job in a termination block if no (or inadequate) code information is found. If the scanner determines in the determination block 1018 that adequate code information was found, then the scanner, in a second query block 1026, queries a copyright server using the code information.

In response to the copyright query, in a record location block 1030, the scanner determines whether the copyright server (or database) located a record corresponding to the code information. If, in the record location block 1030, the scanner determines that the server failed to locate a corresponding record, then the scanner optionally outputs the text and/or image information and/or the code information and an indication that no copyright registration (or application) was located for the scanned text and/or image information. The indication that no copyright registration (or application) was located after a search may be considered code information as well since it is information germane to the text and/or image information.

If, in the record location block 1030, the scanner determines that the server located a copyright record, then in a third query block 1038, the scanner queries a license fee server using code information (e.g., code information from a sender, code information from a copyright server, etc.). In a second record location block 1042, the scanner determines whether the license fee server (or database) located a record corresponding to the code information. If the record location block 1042 fails to locate a corresponding record, then the scanner outputs scanned text and/or image information, code information, an indication that a copyright registration (or application) was located and/or an indication that no license arrangement was located for the for the text and/or image information. The indication that a copyright registration (or application) and/or that no license arrangement was located after a search (or searches) may be considered code information as well since such information is typically germane to the scanned text and/or image information.

If in the record location block 1042 the license fee server locates a license fee record, then in a fourth query block 1050, the scanner queries the scan job sender (or initiator) for agreement with terms provided in the license fee record (e.g., payment of the license fee and/or for agreement with other terms provided in the license fee record). In an agreement determination block 1054, the scanner determines whether the sender agreed with the terms provided in the license fee record. If in the agreement determination block 1054 the scanner determines that the sender does not agree with the terms, then a termination block 1058 follows wherein the scanner terminates the job. If the sender agrees with the terms, then the scanner outputs scanned text and/or image information, code information, and/or an indication that the sender agreed to the terms of a license agreement. Information indicating that a sender has agreed to terms of a license may also be considered code information since it typically pertains to the text and/or image information as output by the printer.

While the exemplary methods 900, 1000 described with reference to FIGS. 9 and 10 refer to acts or blocks performed by a printer and a scanner respectively, some acts may be performed by a separate device, such as, but not limited to, a workstation, a server, a handheld device, etc. For example, in exemplary method 900 any or all of blocks 914 through 958 may be performed by a separate device whereas in exemplary method 100 any or all of blocks 1014 through 1058 may be performed by a separate device.

Referring to FIG. 11, a block diagram of yet another exemplary license agreement method 1100 is shown. In a reception block 1110, a coding device receives code information and text and/or image information (e.g., as a print job and/or a scan). In a detection block 1114, the coding device detects the code information. For example, the coding device may detect a bar code on a document and/or digital code information in a print job. In a connection block 1118, the coding device uses the detected code information to connect to a Web site. In turn, the Web site provides authorship, ownership, and/or license code information related to the text and/or image information. The coding device receives such code information from the Web site in a second reception block 1122. Following reception of the code information from the Web site, the coding device outputs information germane to the text and/or image information. Such information optionally includes license terms or the like in the form of an invoice. The coding device may output such an invoice electronically (e.g., to a display, as an e-mail, etc.) and/or as a hard copy with or without additional information. Alternatively, or in addition to, the coding device may output a hard copy of the text and/or image information together with code information in the form of a watermark or the like.

In various methods described herein, a coding device optionally outputs a “degraded” version of input text and/or image information. For example, a coding device may filter and/or otherwise alter the text and/or image information prior to, during and/or through output. For example, a coding device may output a color image in black and white. Other examples include, but are not limited to, resolution reduction, size reduction, color shifting, redaction, etc.

Although various exemplary methods and/or systems have been described in language specific to structural features and/or methodological blocks, it is to be understood that the content of the appended claims is not necessarily limited to the specific features or blocks described. Rather, the specific features and blocks are disclosed as preferred forms of implementing the claimed content.

1. A coding device comprising:
an input for inputting text and/or image information;
a network interface for receiving code information pertaining to authorship and/or ownership of the text and/or image information; and
a printer for printing the text and/or image information onto a medium based on the code information.

2. The coding device of claim 1 wherein the input comprises a scanner.

3. The coding device of claim 1 wherein the input accepts input from a device selected from the group consisting of keyboards, mice, trackballs, pads, touch screens, telephones, faxes, and modems.

4. The coding device of claim 1 wherein the input accepts input from a device selected from the group consisting of digital storage devices and computers.

5. The coding device of claim 1 wherein the network interface connects to the Internet.

6. The coding device of claim 1 wherein the network interface receives code information from a server.

7. The coding device of claim 1 wherein the code information includes copyright information.

8. The coding device of claim 1 wherein the code information includes a license term.

9. The coding device of claim 1 wherein the code information includes a mark selected from the group consisting of trademarks, watermarks, paid marks, and authorization marks.

10. The coding device of claim 1 further comprising a Web browser.

11. The coding device of claim 1 further comprising a digital filter.

12. The coding device of claim 11, wherein the digital filter filters the text and/or image information based on the code information.

13. A coding device comprising:
an input for inputting text and/or image information;
a network interface for receiving code information pertaining to authorship and/or ownership of the text and/or image information; and
a printer for printing code information and the text and/or image information onto a medium.

14. The coding device of claim 13 wherein the input comprises a scanner.

15. The coding device of claim 13 wherein the network interface receives code information from a server.

16. The coding device of claim 13 wherein the code information includes copyright information.

17. A method of printing text and/or image information comprising:
inputting text and/or image information to a printer;
receiving code information pertaining to authorship and/or ownership of the text and/or image information using the printer; and
printing text and/or image information based on the code information using the printer.

18. The method of claim 17 wherein the inputting comprises scanning.

19. The method of claim 17 wherein the receiving comprises receiving code information via a network.

20. A method of printing text and/or image information comprising:
inputting text and/or image information to a printer;
receiving code information pertaining to authorship and/or ownership of the text and/or image information using the printer; and
printing code information and text and/or image information using the printer.

21. The method of claim 20 wherein the inputting comprises scanning.
